(19) United States
(12) Patent Application Publication
(10) Pub. No.: US 2016/0075377 A1
(43) Pub. Date: Mar. 17, 2016

(54) PARKING ASSIST SYSTEM, PARKING ASSIST METHOD AND PARKING ASSIST CONTROL PROGRAM

(71) Applicants: AISIN SEIKI KABUSHIKI KAISHA, Kariya-shi (JP); TOYOTA JIDOSHA KABUSHIKI KAISHA, Toyota-shi (JP)

(72) Inventors: Motokatsu TOMOZAWA, Nagoya-shi (JP); Masaya KATO, Toyokawa-shi (JP); Hidehiko MIYOSHI, Tajimi-shi (JP); Shogi FUKUKAWA, Nagoya-shi (JP); Motonari OBAYASHI, Nagakute-shi (JP); Keisuke OYAMA, Toyota-shi (JP); Hironobu ISHIJIMA, Toyota-shi (JP)

(73) Assignees: TOYOTA JIDOSHA KABUSHIKI KAISHA, Toyota-shi (JP); AISIN SEIKI KABUSHIKI KAISHA, Kariya-shi (JP)

(21) Appl. No.: 14/850,166

(22) Filed: Sep. 10, 2015

(30) Foreign Application Priority Data
Sep. 12, 2014 (JP) 2014-186781

(51) Int. Cl. B62D 15/02; B60R 1/00

(52) U.S. Cl. CPC B62D 15/0285; B62D 15/024; B60R 1/00; B60R 2300/806; B60R 2300/207

(57) ABSTRACT

A parking assist system for a vehicle including a display device that is arranged behind a steering wheel from a driver and that displays parking assist information and a driving unit that rotationally drives the steering wheel includes an electronic control unit. The electronic control unit is configured to detect that the vehicle has moved through a switching position and reached a predetermined state during parking assist, and, when it is detected that the vehicle has reached the predetermined state, control the driving unit to rotationally drive a rotation angle position of the steering wheel to a rotation angle position at which it is estimated that at least the parking assist information is visually recognizable by the driver.

### INCORPORATION BY REFERENCE

The disclosure of Japanese Patent Application No. 2014-186781 filed on Sep. 12, 2014 including the specification, drawings and abstract is incorporated herein by reference in its entirety.

### BACKGROUND OF THE INVENTION

1. Field of the Invention

The invention relates to a parking assist system, a parking assist method and a parking assist control program.

2. Description of Related Art

As a technique for assisting in parking a vehicle, there is suggested a technique for providing a driver with image data captured as a surrounding environment of the vehicle by a plurality of cameras installed in the vehicle. At this time, there is suggested a technique for assisting in, for example, parking a vehicle by displaying a predicted moving trajectory in the case where the vehicle moves in the future at a steering angle of the vehicle.

In this case, in order to park a vehicle in a place, such as a parking place, in which a movable range of a vehicle is limited, it is generally required to maneuver a steering wheel. Therefore, when a vehicle has reached a switching position at which the steering wheel is turned, a driver is informed through video image that the vehicle has reached the switching position (for example, Japanese Patent Application Publication No. 2012-073836 (JP 2012-073836 A)).

### SUMMARY OF THE INVENTION

For example, when the driver does not recognize the displayed video image showing that the vehicle has reached the switching position or when a display is a meter display and the display is hidden by the steering wheel, information on the display is not visually recognized. When parking assist is performed, it is desired to reliably provide the driver with information at the switching position in a visually recognizable state.

A first aspect of the invention provides a parking assist system for a vehicle. The vehicle includes a display device that is arranged behind a steering wheel from a driver and that displays parking assist information and a driving unit that rotationally drives the steering wheel. The parking assist system includes an electronic control unit. The electronic control unit is configured to detect that the vehicle has moved through a switching position at which the steering wheel is required to turn and reached a predetermined state during parking assist, and, when it is detected that the vehicle has reached the predetermined state, control the driving unit to rotationally drive a rotation angle position of the steering wheel to a rotation angle position at which it is estimated that at least the parking assist information is visually recognizable by the driver.

A second aspect of the invention provides a parking assist method that is executed in a parking assist system mounted on a vehicle including a display device that is arranged behind a steering wheel from a driver and that displays parking assist information. The parking assist method includes: detecting that the vehicle has moved through a switching position at which the steering wheel is required to turn and reached a predetermined state during parking assist; and, when it is detected that the vehicle has reached the predetermined state, rotationally driving a rotation angle position of the steering wheel to a rotation angle position at which it is estimated that at least the parking assist information is visually recognizable by the driver.

A third aspect of the invention provides a control program for controlling, by a computer, a parking assist system mounted on a vehicle including a display device that is arranged behind a steering wheel from a driver and that displays parking assist information and a driving unit that rotationally drives the steering wheel. The control program causes the computer to function as: means for detecting that the vehicle has moved through a switching position at which the steering wheel is required to turn and reached a predetermined state during parking assist; and means for, when it is detected that the vehicle has reached the predetermined state, controlling the driving unit to set a rotation angle position of the steering wheel to a rotation angle position at which it is estimated that at least the parking assist information is visually recognizable by the driver.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an exemplary perspective view of a vehicle according to an embodiment in a state where part of a cabin is seen through;

FIG. 2 is an exemplary plan view (bird's-eye view) of the vehicle according to the embodiment;

FIG. 3 is a view of an example of a dashboard of the vehicle according to the embodiment when viewed from the rear side of the vehicle;

FIG. 4 is an exemplary block diagram of the configuration of a parking assist system according to the embodiment;

FIG. 5 is an exemplary block diagram of the configuration of an ECU of the parking assist system according to the embodiment;

FIG. 6 is a flowchart that shows a schematic process according to the embodiment;

FIG. 7 is a view that illustrates detection of an available parking area;

FIG. 8 is a view that illustrates a reflected portion of an obstacle;

FIG. 9 is a view that illustrates an available parking area;

FIG. 10 is a view that illustrates an example of setting of a moving path;

FIG. 11 is a process flowchart of a parking assist control process;

FIG. 12 is a view that illustrates an example of display at the start of the parking assist control process;

FIG. 13 is a view that illustrates an example of display in the case where a host vehicle position has reached a switching position;

FIG. 14 is a view that illustrates a state of a steering unit during the parking assist control process;

FIG. 15 is a side view for illustrating a method of calculating a visually recognizable position of a display screen of a display device;

FIG. 16 is a plan view for illustrating the method of calculating a visually recognizable position of the display screen of the display device;

FIG. 17 is a view that illustrates a state after the steering unit is driven to a position at which the display device is visually recognizable;

FIG. 18 is a view that illustrates an example of information display at a new switching position;

FIG. 19 is a view that illustrates an example of information display during moving backward; and

FIG. 20 is a view that illustrates an example of display at the end of parking assist.

### DETAILED DESCRIPTION OF EMBODIMENTS

Hereinafter, an exemplary embodiment of the invention will be described. The configuration of the embodiment described below, and the operation, results and advantageous effects obtained from the configuration are illustrative. The invention may be implemented by a configuration other than the configuration that will be described in the following embodiment, and may obtain at least one of various advantageous effects based on a basic configuration or secondary advantageous effects.

A vehicle 1 according to the present embodiment may be, for example, an automobile that uses an internal combustion engine (not shown) as a drive source, that is, an internal combustion engine automobile, may be an automobile that uses an electric motor (not shown) as a drive source, that is, an electric automobile, a fuel-cell automobile, or the like, may be a hybrid automobile that uses both the internal combustion engine and the electric motor as drive sources, or may be an automobile including another drive source. Various transmissions may be mounted on the vehicle 1. Various devices, such as system and components, required to drive an internal combustion engine or an electric motor may be mounted on the vehicle 1. The system, number, layout, and the like, of a device related to driving of wheels 3 in the vehicle 1 may be variously set.

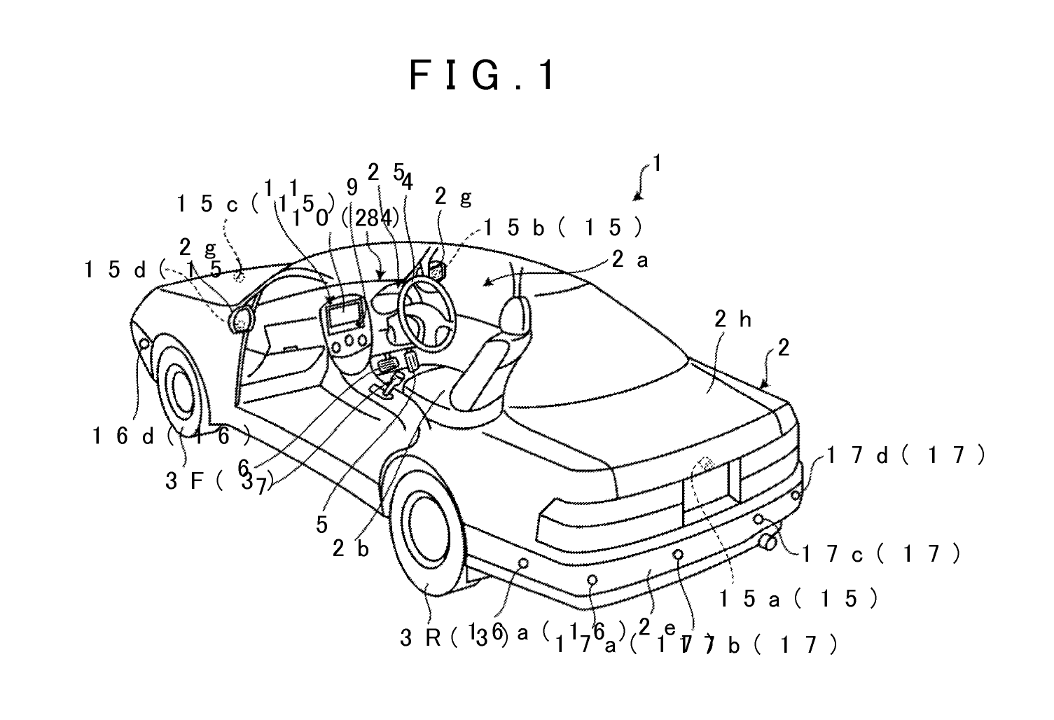

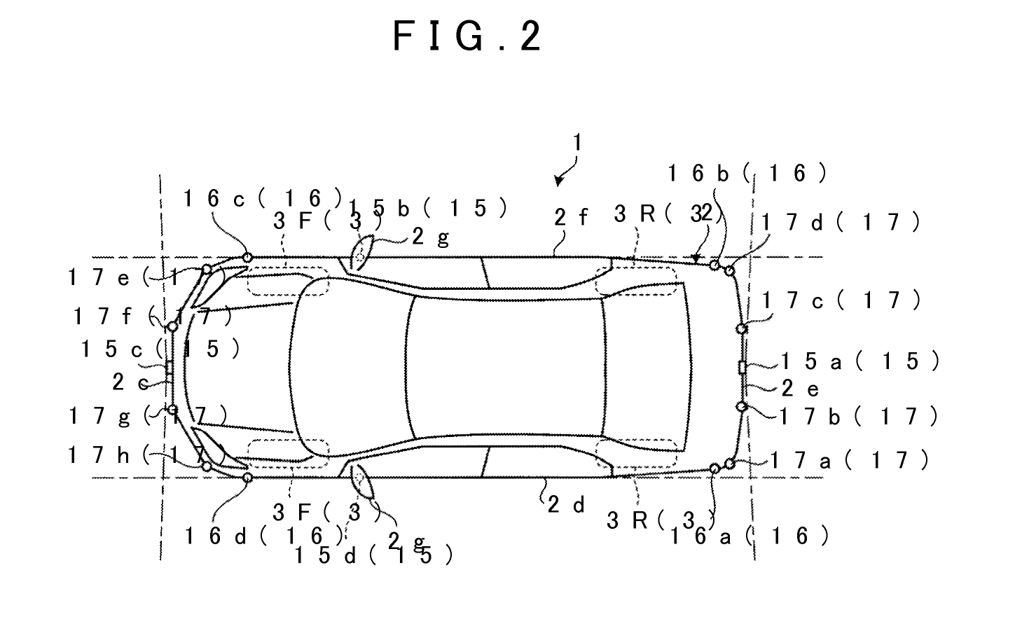

FIG. 1 is an exemplary perspective view of a vehicle according to the embodiment in a state where part of a cabin is seen through. FIG. 2 is an exemplary plan view (bird's-eye view) of the vehicle according to the embodiment. As illustrated in FIG. 1, a vehicle body 2 constitutes a cabin 2a in which an occupant (not shown) is seated. A steering unit 4, an accelerator operation unit 5, a brake operation unit 6, a shift operation unit 7, and the like, are provided near a seat 2b of a driver as an occupant inside the cabin 2a. The steering unit 4 is, for example, a steering wheel projecting from a dashboard 24. The accelerator operation unit 5 is, for example, an accelerator pedal located near driver's foot. The brake operation unit 6 is, for example, a brake pedal located near driver's foot. The shift operation unit 7 is, for example, a shift lever projecting from a center console. The steering unit 4, the accelerator operation unit 5, the brake operation unit 6, the shift operation unit 7, and the like, are not limited to these components.

A display device 8 and an audio output device 9 are provided inside the cabin 2a. The display device 8 serves as a display output unit. The audio output device 9 serves as an audio output unit. The display device 8 is, for example, a liquid crystal display (LCD), an organic electroluminescent display (OELD), or the like. The audio output device 9 is, for example, a speaker. The display device 8 is, for example, covered with a translucent operation input unit 10, such as a touch panel. An occupant is allowed to visually recognize an image that is displayed on the display screen of the display device 8 via the operation input unit 10. An occupant is allowed to perform an input operation by operating the operation input unit 10 through touching, pressing or moving the operation input unit 10 with a finger, or the like, at a position corresponding to an image that is displayed on the display screen of the display device 8. These display device 8, audio output device 9, operation input unit 10, and the like, are, for example, provided in a monitor device 11 located at the center in the vehicle width direction, that is, transverse direction, of the dashboard 24. The monitor device 11 may have an operation input unit (not shown), such as a switch, a dial, a joystick and a push button. An audio output device (not shown) may be provided at another position inside the cabin 2a, different from the monitor device 11. Audio may be output from the audio output device 9 of the monitor device 11 and another audio output device. The monitor device 11 is, for example, shared with a navigation system or an audio system. A display device 12 different from the display device 8 is provided inside the cabin 2a.

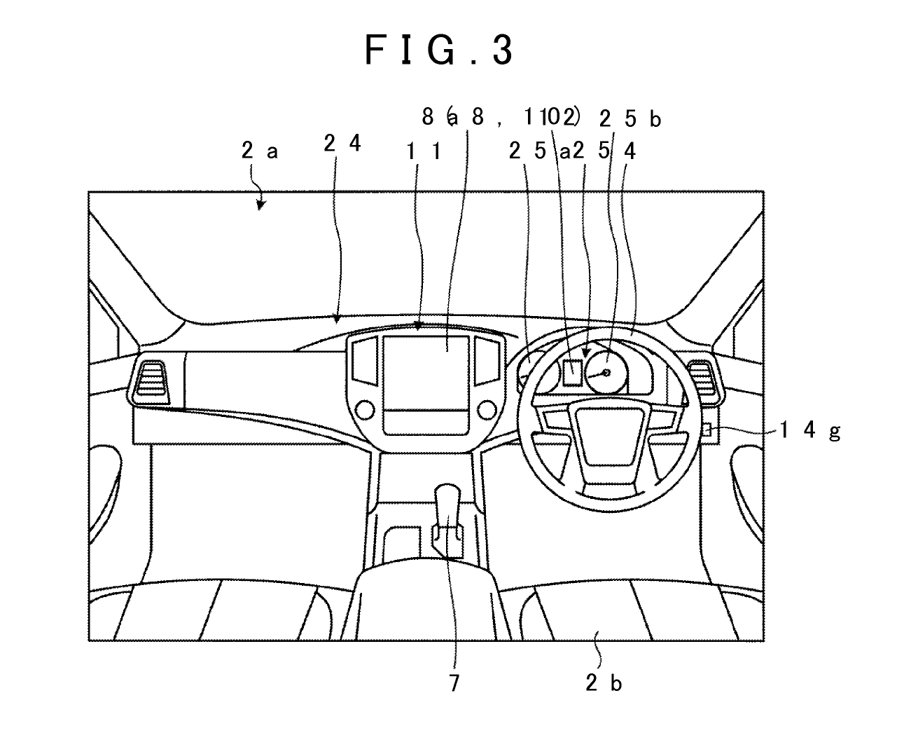

FIG. 3 is a view of an example of a dashboard of the vehicle according to the embodiment when viewed from the rear side of the vehicle. As shown in FIG. 3, the display device 12 is, for example, provided in an instrument panel unit 25 in the dashboard 24, and is located at substantially the center of the instrument panel unit 25 between a speed indicating unit 25a and a rotation speed indicating unit 25b. The size of the screen 12a of the display device 12 is smaller than the size of the screen 8a of the display device 8 (FIG. 3). An image that shows information for assisting in parking the vehicle 1 may be mainly displayed on the display device 12. The amount of information that is displayed on the display device 12 may be smaller than the amount of information that is displayed on the display device 8. The display device 12 is, for example, an LCD, an OELD, or the like. Information that is displayed on the display device 12 may be displayed on the display device 8.

As illustrated in FIG. 1 and FIG. 2, the vehicle 1 is, for example a four-wheel vehicle, and includes two right and left front wheels 3F and two right and left rear wheels 3R. Each of these four wheels 3 may be configured to be steerable.

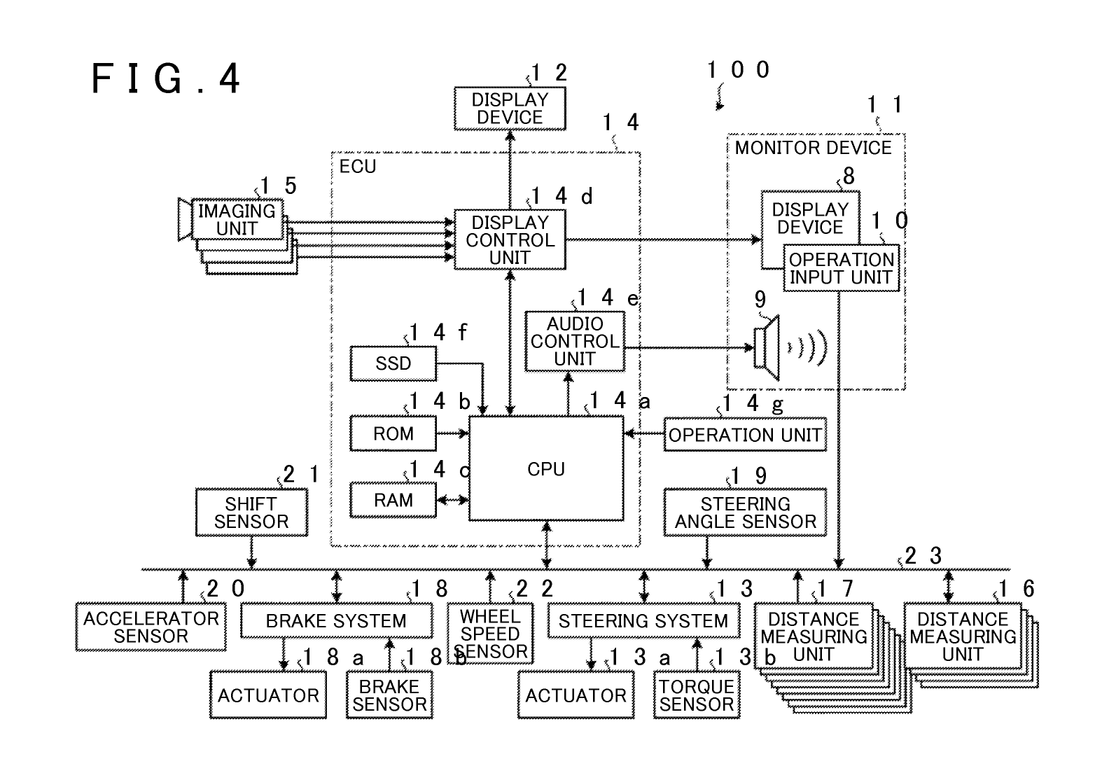

FIG. 4 is an exemplary block diagram of the configuration of a parking assist system according to the embodiment. As illustrated in FIG. 4, the vehicle 1 includes a steering system that steers at least two of the wheels 3. The steering system 13 includes an actuator 13a and a torque sensor 13b. The steering system 13 is electrically controlled by an electronic control unit (ECU) 14, or the like, to actuate the actuator 13a. The steering system 13 is, for example, an electric power steering system, a steer-by-wire (SBW) system, or the like. The steering system 13 adds torque, that is, assist torque, to the steering unit 4 with the use of the actuator 13a to compensate for steering force or steers the wheels 3 with the use of the actuator 13a. In this case, the actuator 13a may steer one of the wheels 3 or may steer a plurality of the wheels 3. The torque sensor 13b, for example, detects a torque that is applied to the steering unit 4 by a driver.

As illustrated in FIG. 2, for example, four imaging units 15a to 15d are provided on the vehicle body 2 as a plurality of imaging units 15. Each of the imaging units 15 is, for example, a digital camera that incorporates an imaging device, such as a charge coupled device (CCD) and a CMOS image sensor (CIS). Each of the imaging units 15 is able to output moving image data at a predetermined frame rate. Each of the imaging units 15 has a wide angle lens or a fisheye lens, and is able to capture an image in, for example, the range of 140° to the range of 190° in the horizontal direction. The optical axis of each of the imaging units 15 is set so as to be oriented obliquely downward. Thus, each of the imaging units 15 sequentially captures a road surface on which the vehicle 1 is allowed to move and an outside environment around the vehicle body 2, including an area in which the vehicle 1 is allowed to be parked, and outputs the captured image as captured image data.

The imaging unit 15a is, for example, located at a rear end 2e of the vehicle body 2, and is provided at a lower wall portion of a door 2h of a rear boot. The imaging unit 15b is, for example, located at a right-side end 2f of the vehicle body 2, and is provided at a right-side door mirror 2g. The imaging unit 15c is, for example, located at the front of the vehicle body 2, that is, a front end 2c in the vehicle longitudinal direction, and is provided at a front bumper, or the like. The imaging unit 15d is, for example, located at the left side of the vehicle body 2, that is, a left-side end 2d in the vehicle width direction, and is provided at a door mirror 2g that serves as a left-side projecting portion. The ECU 14 is able to generate an image having a wider viewing angle or generate an imaginary bird's-eye image of the vehicle 1 from above by executing operation processing and image processing on the basis of the image data obtained by the imaging units 15. A bird's-eye image may be referred to as plan image.

The ECU 14 identifies partition lines, or the like, on a road surface around the vehicle 1 from the images of the imaging units 15, and detects (extracts) parking spaces indicated by the partition lines, or the like.

As illustrated in FIG. 1 and FIG. 2, for example, four distance measuring units 16a to 16d and eight distance measuring units 17a to 17h are provided on the vehicle body 2 as a plurality of distance measuring units 16, 17. Each of the distance measuring units 16, 17 is, for example, a sonar that emits ultrasonic wave and captures the reflected wave. The sonar may also be referred to as a sonar sensor or an ultrasonic detector. The ECU 14 is able to detect whether there is an object, such as an obstacle, located around the vehicle 1 or measure a distance to the object on the basis of the detected results of the distance measuring units 16, 17. That is, each of the distance measuring units 16, 17 is an example of a detection unit that detects an object. Each of the distance measuring units 17 may be, for example, used to detect an object at a relatively close distance. Each of the distance measuring units 16 may be, for example, used to detect an object at a relatively long distance, which is distant from an object that each of the distance measuring units 17 detects. The distance measuring units 17 may be, for example, used to detect an object ahead of or behind the vehicle 1. The distance measuring units 16 may be, for example, used to detect an object to the side of the vehicle 1.

As illustrated in FIG. 4, in a parking assist system 100, in addition to the ECU 14, the monitor device 11, the steering system 13, the distance measuring units 16, 17, and the like, a brake system 18, a steering angle sensor 19, an accelerator sensor 20, a shift sensor 21, a wheel speed sensor 22, and the like, are electrically connected to one another via an in-vehicle network 23 that serves as an electric communication line.

The in-vehicle network 23 is, for example, provided as a controller area network (CAN). The ECU 14 is able to control the steering system 13, the brake system 18, and the like, by transmitting control signals through the in-vehicle network 23. The ECU 14 is able to receive detected results of the torque sensor 13b, a brake sensor 18b, the steering angle sensor 19, the distance measuring units 16, the distance measuring units 17, the accelerator sensor 20, the shift sensor 21, the wheel speed sensor 22, and the like, and operation signals of the operation input unit 10, and the like, via the in-vehicle network 23.

The ECU 14, for example, includes a central processing unit (CPU) 14a, a read only memory (ROM) 14b, a random access memory (RAM) 14c, a display control unit 14d, an audio control unit 14e, a solid state drive or flash memory (SSD) 14f, and the like. The CPU 14a is, for example, able to execute various operation processing and control, such as image processing related to images that are displayed on the display devices 8, 12, determination of a moving target position of the vehicle 1, computation of a moving path of the vehicle 1, determination as to whether there is an interference with an object, automatic control over the vehicle 1, and cancellation of automatic control. The CPU 14a is able to read a program installed and stored in a nonvolatile storage device, such as the ROM 14b, and execute operation processing in accordance with the program. The RAM 14c temporarily stores various pieces of data that are used for computation in the CPU 14a. The display control unit 14d mainly executes image processing by the use of image data obtained by the imaging units 15, synthesis of image data that are displayed on the display device 8, and the like, within the operation processing in the ECU 14. The audio control unit 14e mainly processes audio data that are output from the audio output device 9 within the operation processing in the ECU 14. The SSD 14f is a rewritable nonvolatile storage unit, and is able to store data even when the power of the ECU 14 is turned off. The CPU 14a, the ROM 14b, the RAM 14c, and the like, may be integrated within the same package. The ECU 14 may be formed of another logical operation processor, such as a digital signal processor (DSP), a logical circuit, or the like, instead of the CPU 14a. A hard disk drive (HDD) may be provided instead of the SSD 14f. The SSD 14f or the HDD may be provided separately from the ECU 14.

The brake system 18 is, for example, an anti-lock brake system (ABS) that prevents the brake from locking up the wheels, a side slip prevention device (electronic stability control (ESC)) that prevents a side slip of the vehicle 1 during cornering, an electric brake system that enhances brake force (performs brake assist), a brake-by-wire (BBW), or the like. The brake system 18 imparts braking force to the wheels 3 and then, the vehicle 1, via the actuator 18a. The brake system 18 is able to execute various controls by detecting locking up of the wheels by the brake, a spin of the wheels 3, a sign of a side slip, and the like, from, for example, a rotation difference between the right and left wheels 3. The brake sensor 18b is, for example, a sensor that detects the position of a movable unit of the brake operation unit 6. The brake sensor 18b is, for example, a sensor that detects the position of a brake pedal that serves as a movable unit of the brake operation unit 6. The brake sensor 18b includes a displacement sensor.

The steering angle sensor 19 is, for example, a sensor that detects a steering amount of the steering unit 4, such as the steering wheel. The steering angle sensor 19 is, for example, provided by using a Hall element, or the like. The ECU 14 acquires a driver's steering amount of the steering unit 4, a steering amount of each wheel 3 during automatic steering, or the like, from the steering angle sensor 19, and executes various controls. The steering angle sensor 19 detects a rotation angle of a rotating portion included in the steering unit 4. The steering angle sensor 19 is an example of an angle sensor.

The accelerator sensor 20 is, for example, a sensor that detects the position of a movable unit of the accelerator operation unit 5. The accelerator sensor 20 is able to detect the position of the accelerator pedal that serves as the movable unit. The accelerator sensor 20 includes a displacement sensor.

The shift sensor 21 is, for example, a sensor that detects the position of a movable unit of the shift operation unit 7. The shift sensor 21 is able to detect the position of a lever, an arm, a button, or the like, that serves as the movable unit of the shift operation unit 7. The shift sensor 21 may include a displacement sensor or may be provided as a switch.

The wheel speed sensor 22 is a sensor that detects a rotation amount or rotation speed of each wheel 3 per unit time. The wheel speed sensor 22 outputs a wheel speed pulse number, indicating the detected rotation speed, as a sensor value. The wheel speed sensor 22 may be, for example, provided by using a Hall element, or the like. The ECU 14 computes a moving amount, and the like, of the vehicle 1 on the basis of the sensor value acquired from the wheel speed sensor 22, and executes various controls. There is a case where the wheel speed sensor 22 is provided in the brake system 18. In this case, the ECU 14 acquires the detected result of the wheel speed sensor 22 via the brake system 18.

The configurations, arrangement, electrical connection modes, and the like, of the above-described various sensors and actuators are illustrative, and may be variously set (changed).

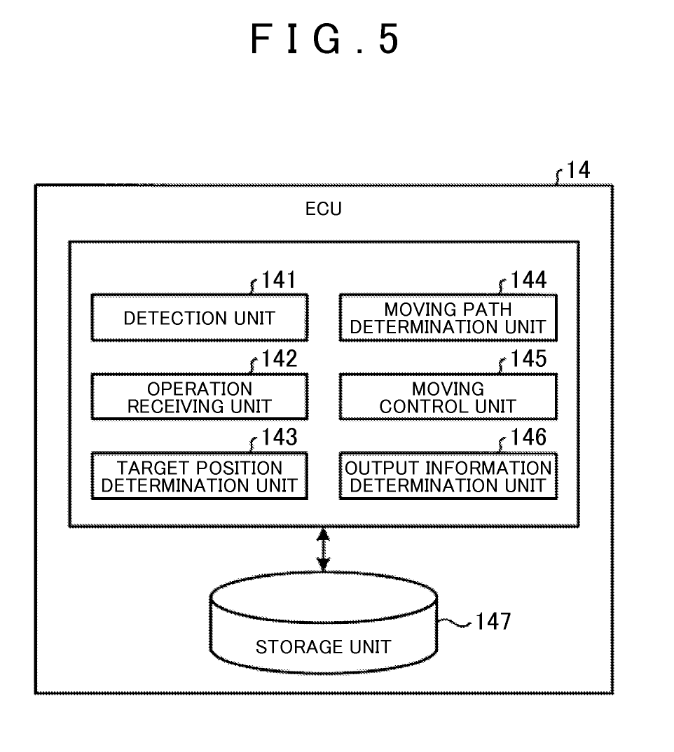

In the present embodiment, the ECU 14 implements at least part of the function of a parking assist system by cooperation between hardware and software (control program). FIG. 5 is a functional configuration block diagram of the ECU. As shown in FIG. 5, the ECU 14 functions as a detection unit 141, an operation receiving unit 142, a target position determination unit 143, a moving path determination unit 144, a moving control unit 145, an output information determination unit 146 and a storage unit 147.

In the above configuration, the detection unit 141 detects an obstacle, such as another vehicle and a pole, a frame line, such as a parking space line, and the like. The operation receiving unit 142 acquires an operation signal that is input through operation of an operation unit 14g. The operation unit 14g is, for example, formed of a push button, a switch, or the like, and outputs an operation signal.

The target position determination unit 143 determines a moving target position (parking target position) of the vehicle 1. The moving path determination unit 144 determines a moving path of the vehicle 1 to the moving target position. The moving control unit 145 controls the portions of the vehicle 1 such that the vehicle 1 moves to the moving target position (parking target position) along the moving path.

The output information determination unit 146 determines information that is output through the display device 12, the display device 8, the audio output device 9, or the like, and determines an output mode of the information, and the like. The storage unit 147 stores data that are used in computation in the ECU 14 or data calculated in computation in the ECU 14.

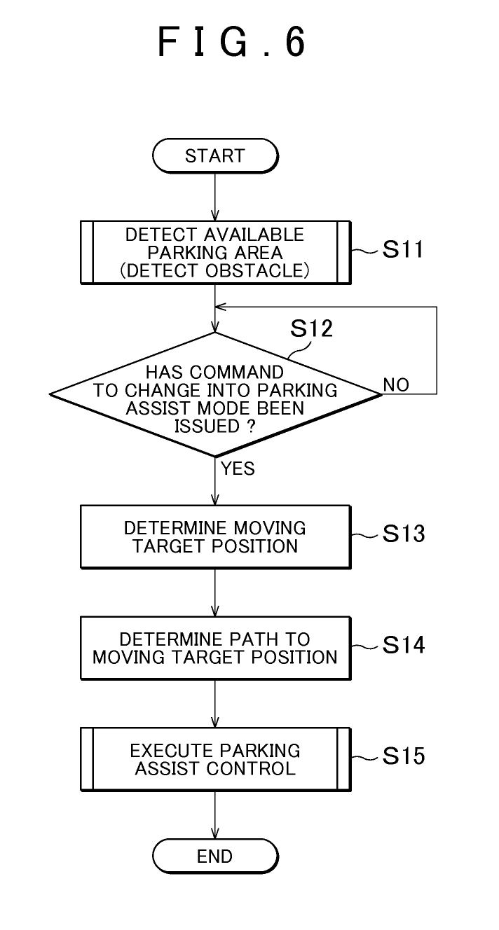

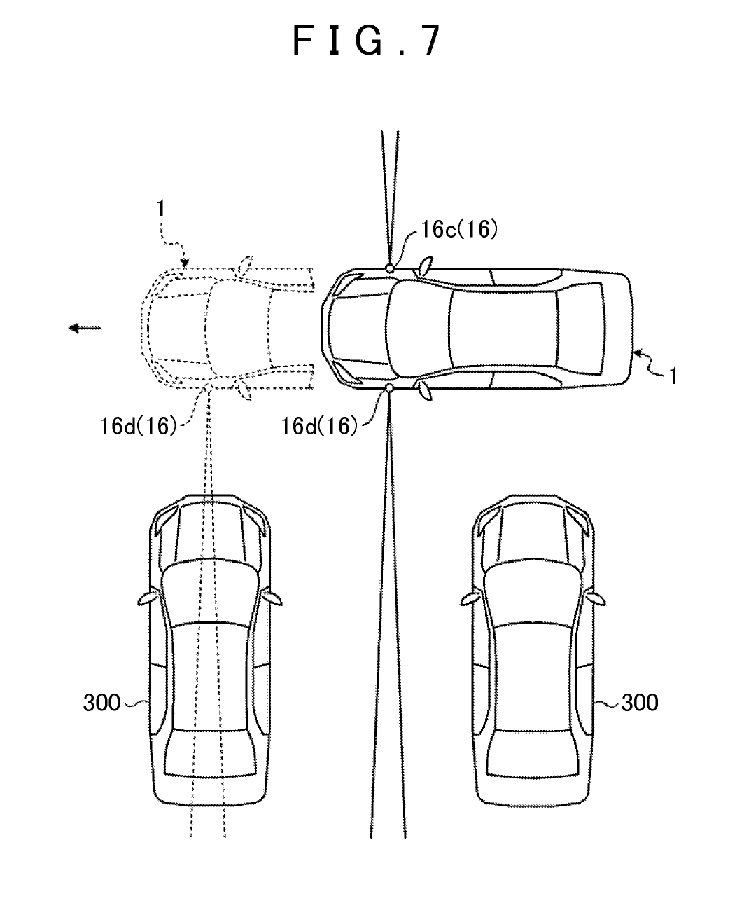

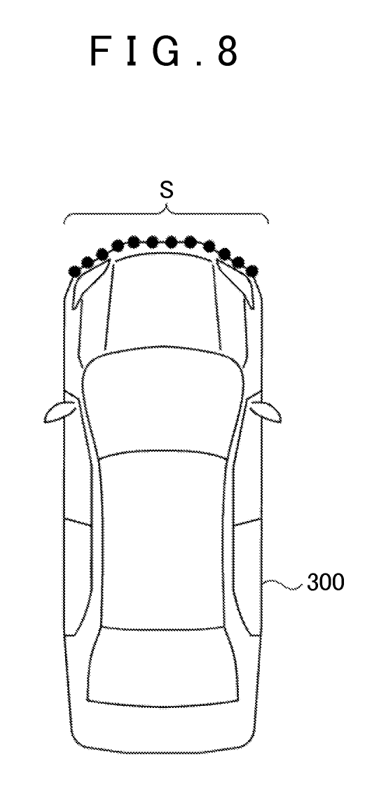

Next, the operation of the embodiment will be described. FIG. 6 is a flowchart of a schematic process according to the embodiment. Initially, the ECU 14 detects an available parking area (detects an obstacle) (step S11). FIG. 7 is a view that illustrates detection of an available parking area. FIG. 8 is a view that illustrates a reflected portion of an obstacle.

Specifically, the distance measuring units 16c, 16d calculate a distance to an obstacle, such as another vehicle 300, at intervals of predetermined sampling timing, and outputs the distance as data corresponding to a reflected portion S (a set of reflected points of a sonic wave, or the like) of the obstacle. The output data are, for example, stored in the RAM 14c at output intervals.

The ECU 14 functions as the detection unit 141, and detects available parking areas 201 located on both right and left sides of the vehicle 1 independently of each other on the basis of the output data of the distance measuring units 16c, 16d. For the sake of easy understanding, a method of detecting the available parking area 201 on the left side of the vehicle 1 will be described.

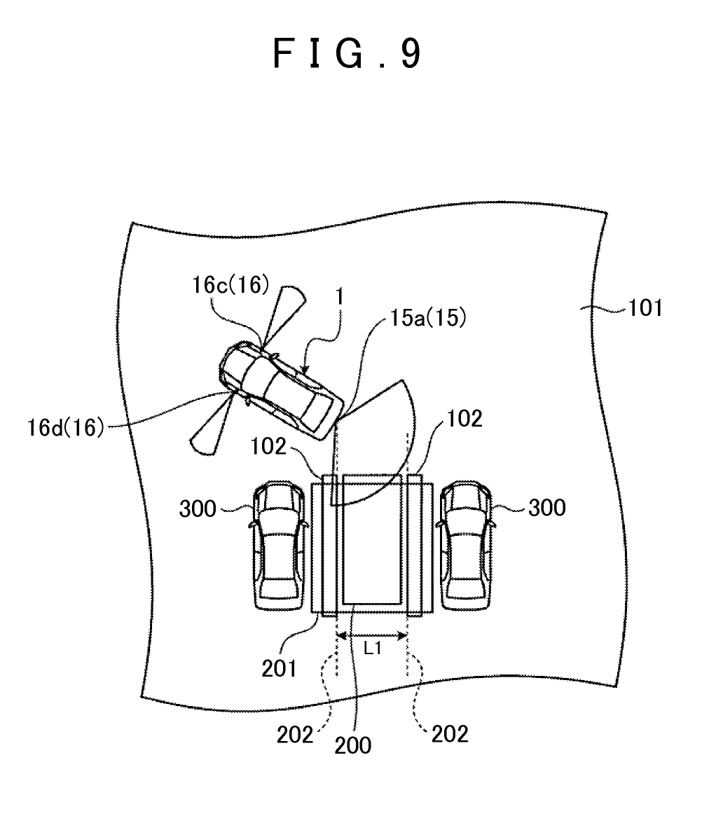

FIG. 9 is a view that illustrates an available parking area. The detection unit 141 determines that there is the available parking area 201 when output data corresponding to an obstacle are output for a period longer than or equal to a period corresponding to a first predetermined duration and, after that, when output data corresponding to the case where there is no obstacle (including the case where a distance to an obstacle is longer than or equal to the vehicle longitudinal length required for the vehicle to park) are output for a period longer than or equal to a second predetermined duration corresponding to a minimum width required as an area in which the vehicle 1 is allowed to be parked.

The detection unit 141 detects a parking space line 102, such as a white line, provided on a traveling surface, such as a ground surface and a road surface, on the basis of captured data output from the imaging unit 15a that captures the rear side of the vehicle 1. More specifically, the detection unit 141 detects a parking space line 102 by applying edge extraction to captured data output from the imaging units 15a to 15d in process in which the vehicle 1 moves backward, in process in which the vehicle 1 moves forward, or during a stop of the vehicle 1.

Subsequently, the ECU 14 functions as the operation receiving unit 142, and determines whether a command to change into the parking assist mode has been issued via the operation unit 14g (step S12). When it is determined in step S12 that a command to change into the parking assist mode has not been issued via the operation unit 14g yet (No in step S12), the process enters a standby state.

When it is determined in step S12 that a command to change into the parking assist mode has been issued via the operation unit 14g (Yes in step S12), the ECU 14 functions as the target position determination unit 143, and determines a moving target position (parking target position) 200 of the vehicle 1 (step S13). Subsequently, the ECU 14 functions as the moving path determination unit 144, and determines a moving path to the moving target position 200 of the vehicle 1 (step S14).

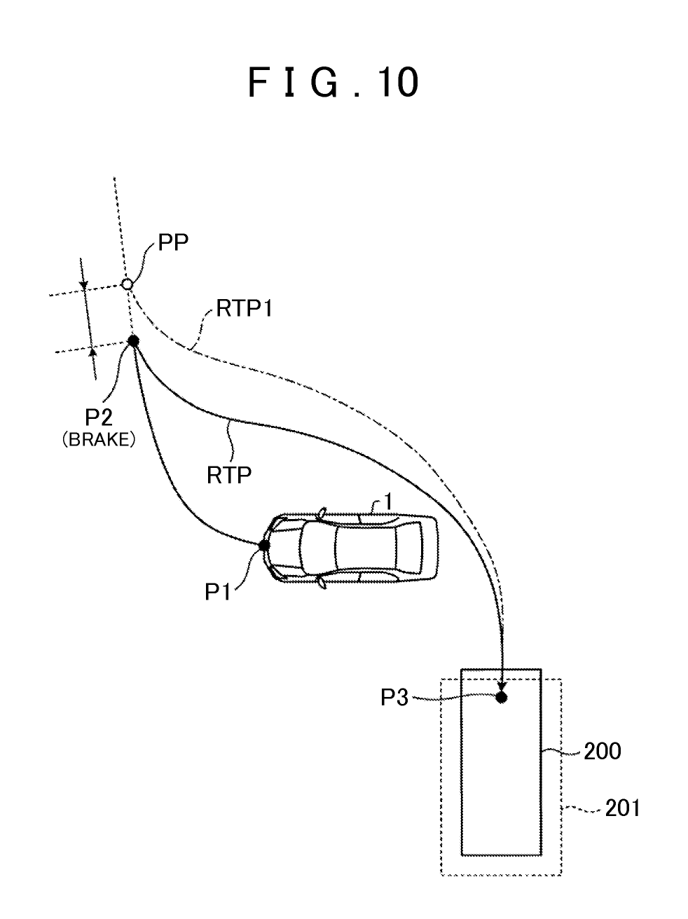

FIG. 10 is a view that illustrates an example of a set moving path. For the sake of simplification of description, the case of the moving path in which the switching position of the steering wheel that serves as the steering unit 4 which is required to turn is one will be described with reference to FIG. 10. The switching position may be regarded as a position at which the steering wheel is required to turn and at which a moving direction of the vehicle is changed between a forward direction and a reverse direction.

In the moving path RTP shown in FIG. 10, the vehicle 1 is moved forward from an initial position P1 at the start of a parking assist control process toward the switching position P2 of the steering wheel that serves as the steering unit 4 by turning the steering wheel rightward by a predetermined amount, the vehicle 1 is stopped at the switching position P2 by depressing the brake that serves as the brake operation unit 6, the gear is changed into reverse, and the vehicle 1 is moved toward the parking target position P3 while turning the steering wheel that serves as the steering unit 4 leftward.

When the moving path RTP is determined, the ECU 14 changes into parking assist control (step S15).

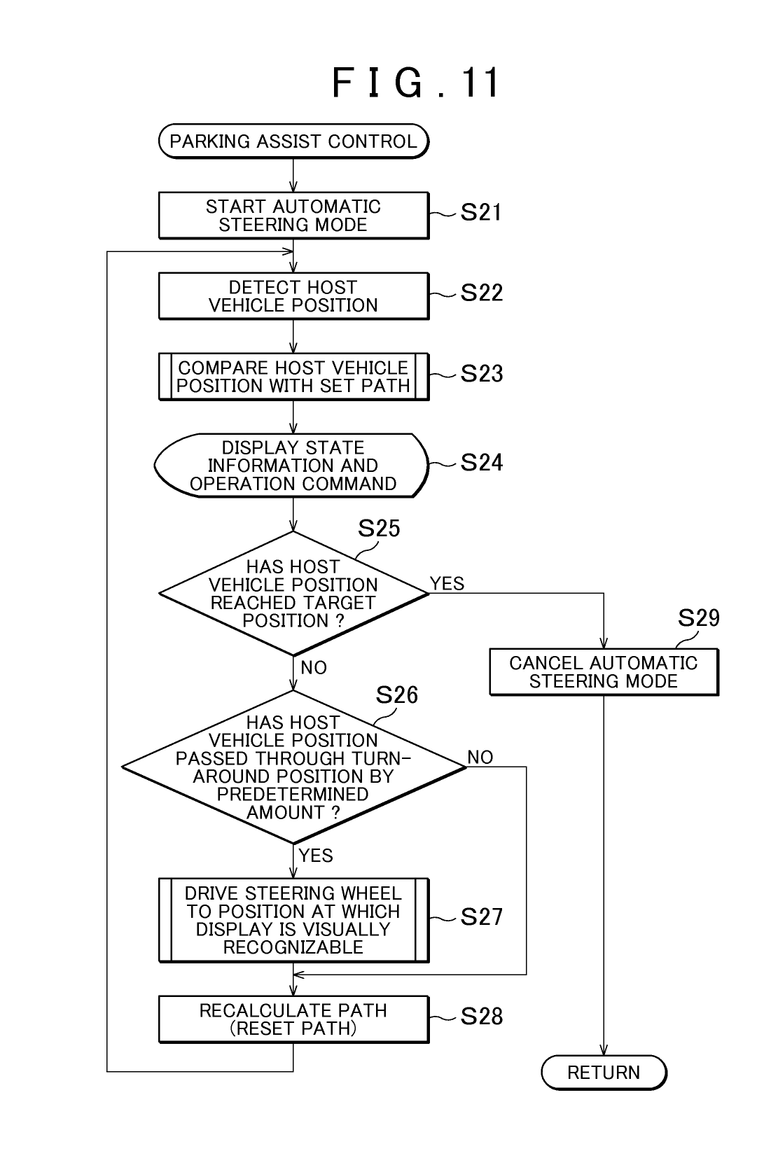

FIG. 11 is a process flowchart of a parking assist control process. Initially, the ECU 14 functions as the moving control unit 145, starts the automatic steering mode for automatic steering in order to control the portions of the vehicle 1 such that the vehicle 1 moves to the parking target position that is the moving target position along the moving path (step S21).

In this automatic steering mode, the driver does not need to operate the steering unit 4, specifically, the steering wheel. Creeping in which the driving force of the engine is transmitted without depressing operation of the accelerator pedal, which is an operation of the accelerator operation unit 5, is utilized for the forward driving force and reverse driving force of the vehicle 1 during the parking assist control process.

Therefore, the driver just operates the brake pedal that serves as the brake operation unit 6 and the shift lever that serves as the shift operation unit 7 in accordance with display on the display device 12. Subsequently, the moving control unit 145 detects a host vehicle position (step S22). Specifically, the ECU 14 detects the host vehicle position by calculating a distance and a direction that are a moving amount from the initial position P1 on the basis of the steering amount of the steering unit 4, detected by the steering angle sensor 19, and the vehicle speed detected by the wheel speed sensor 22.

Thus, the ECU 14 compares the set path with the host vehicle position (step S23), functions as the output information determination unit 146 to determine information about the state of the vehicle and an operation command to the driver and display the information about the state of the vehicle and the operation command on the display device 12 (step S24).

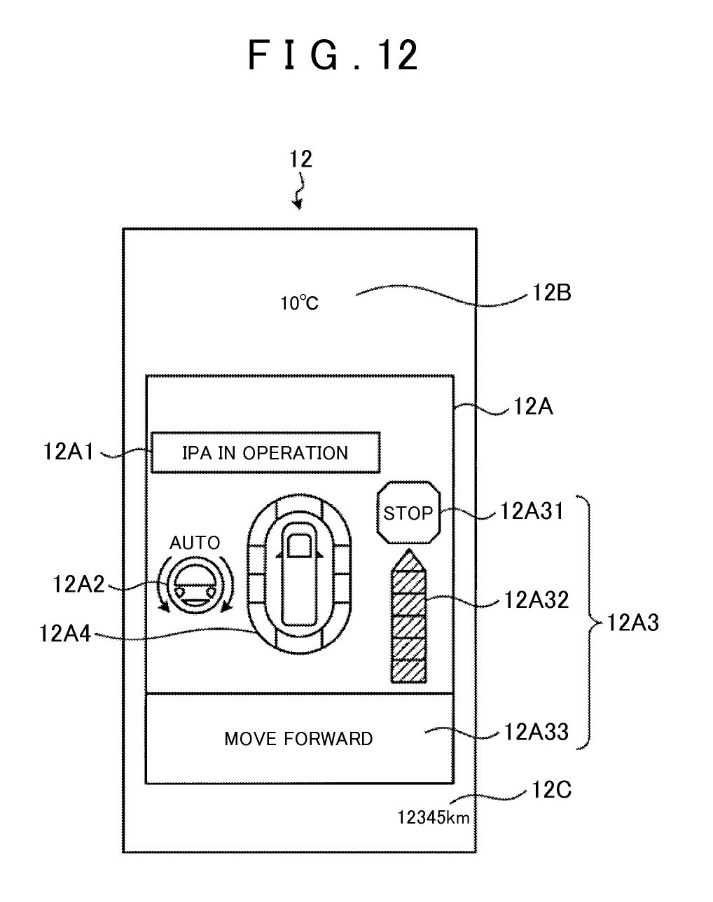

FIG. 12 is a view that illustrates an example of display at the start of the parking assist control process. The display screen of the display device 12 roughly includes a parking assist information display region 12A, a selected information display region 12B and a travel distance information display region 12C. The parking assist information display region 12A displays various pieces of information about parking assist. The selected information display region 12B displays various pieces of information selected in advance. The travel distance information display region 12C is able to display information about an odometer or a trip meter.

The parking assist information display region 12A includes a parking assist display region 12A1, an automatic steering symbol display region 12A2, an operation command display region 12A3 and an obstacle display region 12A4. The parking assist display region 12A1 displays that parking assist (intelligent parking assist (IPA)) is in operation when it is actually in operation. The automatic steering symbol display region 12A2 displays a symbol that indicates that it is in the automatic steering mode during the automatic steering mode. The operation command display region 12A3 displays an operation command to the driver. The obstacle display region 12A4 displays a direction in which an obstacle is located when it is detected by the distance measuring units 16, 17 that the obstacle is located within a predetermined distance range around the vehicle 1.

In the above configuration, as shown in FIG. 12, a braking operation symbol 12A31, a distance indication symbol 12A32 and a command display region 12A33 are displayed in the operation command display region 12A3. The braking operation symbol 12A31 is set in a lit state at the time when a command to operate the brake that serves as the brake operation unit 6 is issued. The distance indication symbol 12A32 indicates a measure of a distance to the switching position of the steering wheel that serves as the steering unit 4 or a measure of a distance to the moving target position by stepwisely changing from a fully lit state to an unlit state. The command display region 12A33 displays details of a command to the driver.

That is, in the case of FIG. 12, the display device 12 displays that parking assist is in operation, it is in the automatic steering mode, a distance to the switching position P2 of the steering wheel that serves as the steering unit 4 or the parking target position P3 that serves as the moving target position is still left near 100%, and the details of a command instructs the driver to stop depressing the brake pedal that serves as the brake operation unit 6 and allows the vehicle 1 to move forward by creeping.

Subsequently, the ECU 14 functions as the moving control unit 145, and determines whether the host vehicle position has reached the parking target position P3 that serves as the target position (step S25).

In this case, because it is determined in step S25 that the host vehicle position has not reached the parking target position P3 that serves as the target position yet (No in step S25), it is determined whether the host vehicle position has passed the switching position P2 by a predetermined amount (step S26).

The predetermined amount is represented by a distance from the switching position P2 or an elapsed time from time at which the host vehicle position has passed through the switching position P2. That is, the predetermined amount corresponds to the timing at which the ECU 14 is allowed to reliably determine that the driver has not visually recognized parking assist information about the switching position P2.

In this case, because it is determined in step S26 that the host vehicle position has not passed through the switching position P2 by the predetermined amount yet (No in step S26), the ECU 14 functions as the moving path determination unit 144 again, recalculates a moving path, and resets a moving path (step S28). This is because the vehicle 1 does not always travel along a set moving path depending on a road surface condition, or the like, and, therefore, an optimal moving path is kept commensurately with an actual condition. The ECU 14 proceeds to step S22 again, and repeats a similar process thereafter.

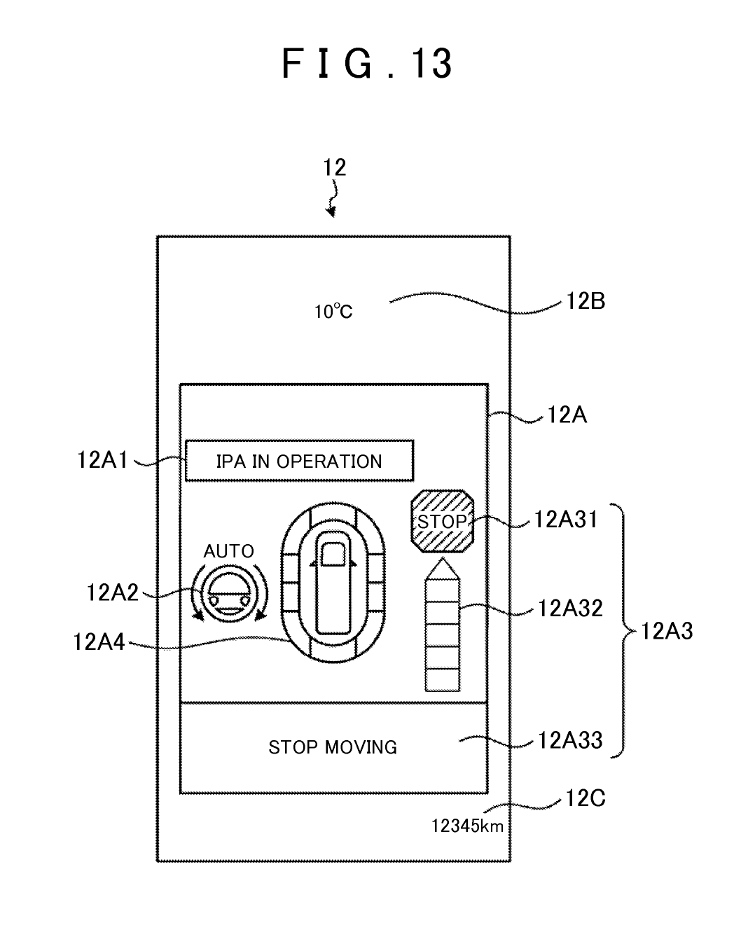

FIG. 13 is a view that illustrates an example of display in the case where the host vehicle position has reached the switching position. The ECU 14 detects the host vehicle position (step S22), and compares the host vehicle position with the set path (step S23). As a result, when the host vehicle position has reached the switching position P2 of the steering wheel that serves as the steering unit 4, the ECU 14 sets the braking operation symbol 12A31 in a lit state, displays, for example, “STOP MOVING” in the command display region 12A33, and issues a command to operate the brake that serves as the brake operation unit 6 to the driver (step S24).

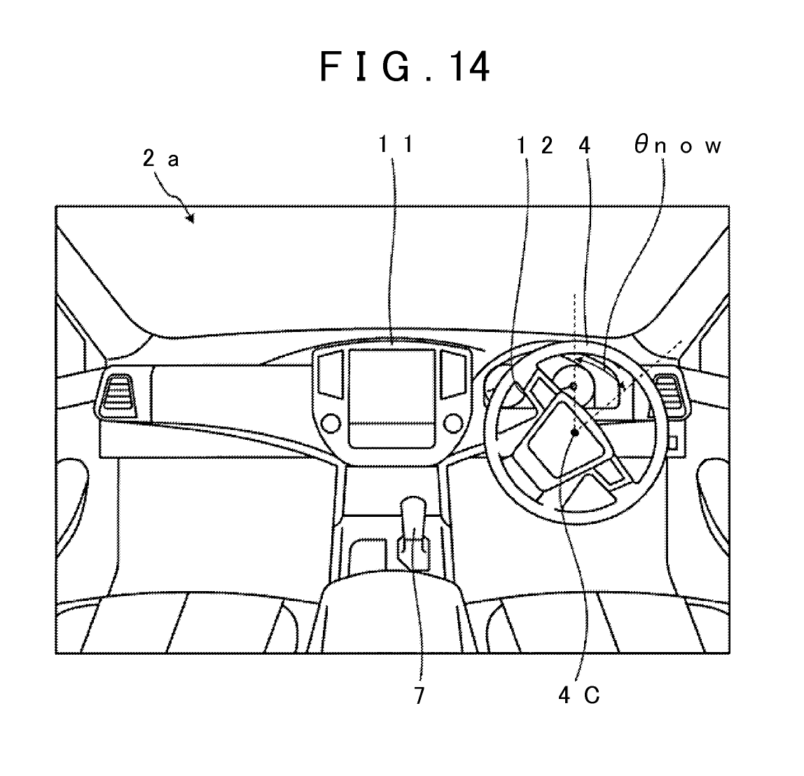

FIG. 14 is a view that illustrates a state of the steering unit during the parking assist control process. Incidentally, as shown in FIG. 14, there may arise a state where the steering wheel that serves as the steering unit 4 is further turned rightward from a neutral position (or 360-degree or 720-degree rotation position) (the current rotation angle position of the steering wheel=θnow) and the driver cannot visually recognize the parking assist information display region 12A in the display screen of the display device 12 because the spoke of the steering wheel is interposed between the parking assist information display region 12A and the driver's eyes. The ECU 14 stores the current rotation angle position θnow of the steering wheel at the time of driving the actuator 13a, and holds the current rotation angle position θnow of the steering wheel.

In such a case, the driver may not realize an operation command. Thus, the driver does not operate the brake that serves as the brake operation unit 6. As a result, the vehicle 1 continues to travel and reaches a position PP (FIG. 10) at which the vehicle 1 has passed through the switching position P2 by the predetermined amount. In FIG. 10, one position PP is shown; however, depending on a moving trajectory of the vehicle 1, a position PP may be on the circumference of a predetermined circle having a center at the switching position P2 or within a doughnut-shaped ring area having a center at the switching position P2.

Thus, when it is determined in step S25 that the host vehicle position has not reached the target position (No in step S25), and when it is determined in step S26 that the host vehicle position has passed through the switching position P2 by the predetermined amount (Yes in step S26), the ECU 14 assumes that display of the display device 12 is not visually recognized by the driver because of the steering wheel that serves as the steering unit 4, and drives the steering wheel that serves as the steering unit 4 to a position at which the display screen of the display device 12 is visually recognizable (step S27). A method of calculating the position at which the display screen of the display device 12 is visually recognizable in the steering wheel that serves as the steering unit 4 will be described.

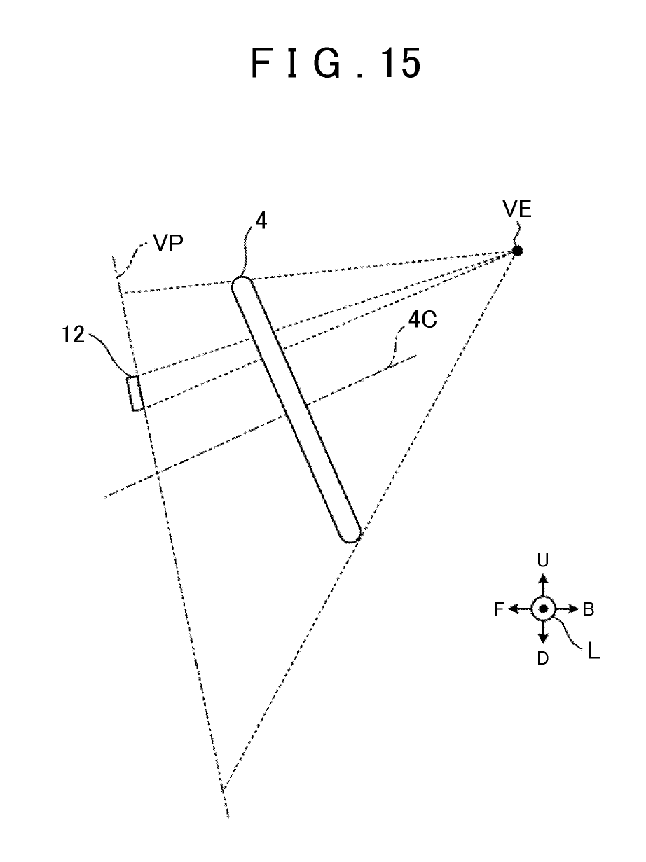

FIG. 15 is a side view for illustrating a method of calculating the visually recognizable position of the display screen of the display device. FIG. 15 shows the positional relationship among the display screen of the display device 12, the steering wheel that serves as the steering unit 4 and an imaginary position VE estimated as a driver's eye position when viewed from the left (L) side of the vehicle 1.

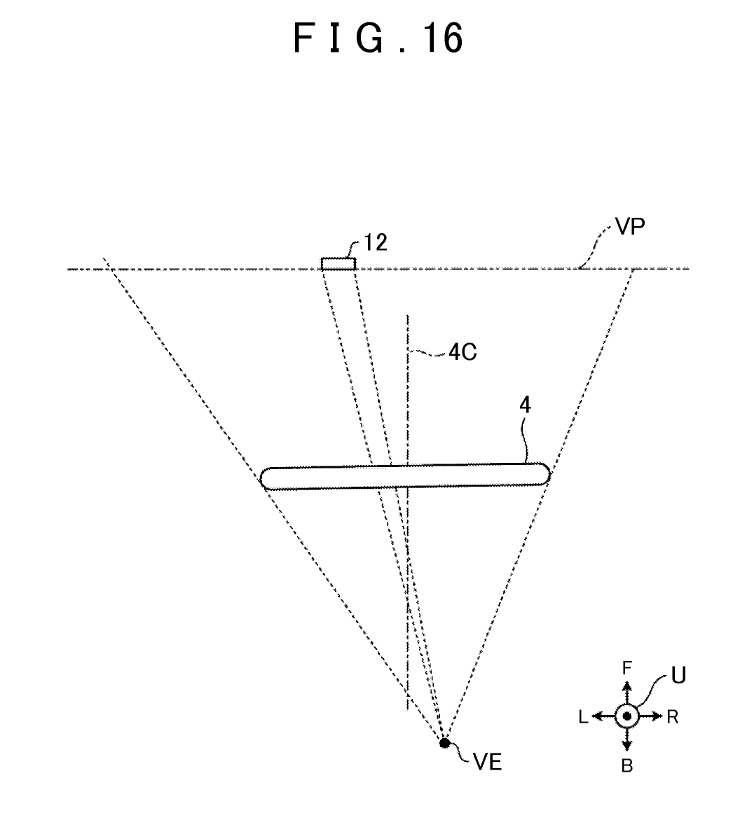

FIG. 16 is a plan view for illustrating the method of calculating the visually recognizable position of the display screen of the display device. FIG. 16 shows the positional relationship among the display screen of the display device 12, the steering wheel that serves as the steering unit 4 and the imaginary position VE estimated as the driver's eye position when viewed from the upper (U) side of the vehicle 1.

In the case of FIG. 15 and FIG. 16, as for the driver's eye position corresponding to the imaginary position VE, for example, a detected eye position of a driver monitoring device for detecting a drowsy driver, or the like, may be set for the imaginary position VE, or a direction in which a rear-view minor, such as an inner rear-view minor or an outer rear-view mirror, is oriented may be detected and a position a predetermined distance forward from a driver's seat in the detected direction may be set for the imaginary position VE.

At the current rotation angle position θnow of the steering wheel shown in FIG. 14, because it is recognized that the display screen of the display device 12 is located within the shadow of the steering wheel that serves as the steering unit 4 that is projected onto an imaginary plane VP including the display screen of the display device 12, the ECU 14 functions as an angle calculation unit, arranges a point light source at the imaginary position VE, and calculates a rotation angle position (=a rotation angle position θc (described later)) of the steering wheel such that the display screen of the display device 12 is not located within the shadow of the steering wheel that serves as the steering unit 4 that is projected onto the imaginary plane VP including the display screen of the display device 12.

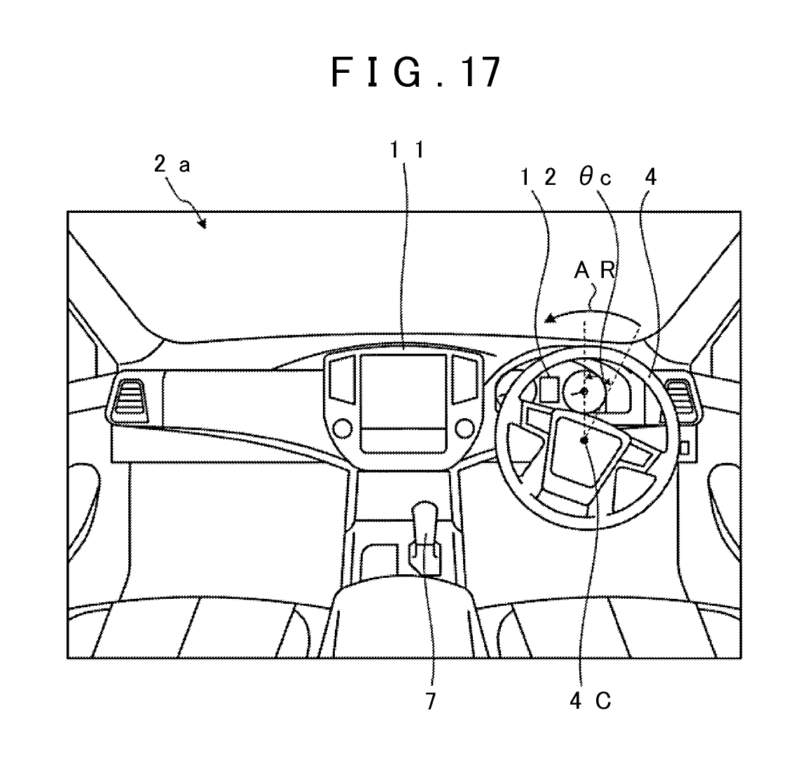

FIG. 17 is a view that illustrates a state after the steering unit is driven to a position at which the display device is visually recognizable. On the assumption that a point light source is arranged at the imaginary position VE and the steering wheel that serves as the steering unit 4 is rotated about a rotation central axis 4C as a rotation center such that the display screen of the display device 12 is not located within the shadow of the steering wheel that serves as the steering unit 4 that is projected onto the imaginary plane VP including the display screen of the display device 12, the rotation angle position is calculated.

However, there are many rotation angle positions of the steering wheel, at which display of the display device 12 is visually recognizable, so the ECU 14 that functions as the angle calculation unit determines a state of the steering wheel (i.e., a rotation angle position of the steering wheel) where a rotation driving amount is the smallest among many rotation angle positions of the steering wheel.

Specifically, the rotation angle position θc that corresponds to a state where the steering wheel is rotated in an arrow AR direction shown in FIG. 17 from the state of the steering wheel that serves as the steering unit 4 shown in FIG. 14 (rotation angle position=θnow) is calculated. the ECU 14 rotationally drives the steering unit 4 by driving the actuator 13a via the steering system 13 to set the rotation angle position at θc, thus placing the display screen of the display device 12 visually recognizable from the driver.

Therefore, the driver is allowed to reliably acquire information (for example, see FIG. 13) that is displayed on the display device 12, is allowed to reliably perform operation of the vehicle 1, required during parking assist, and is allowed to reliably perform parking. More specifically, in the case of the example shown in FIG. 13, the driver does not significantly deviate from the switching position P2, and is allowed to stop the vehicle 1 by reliably depressing the brake pedal that serves as the movable unit of the brake operation unit 6.

The ECU 14 functions as the moving path determination unit 144 again, recalculates a moving path, and resets a moving path (step S28). Thus, even when the vehicle 1 has reached the position PP through the switching position P2 because of the fact that the display screen of the display device 12 is located behind the steering wheel (particularly, spoke) that serves as the steering unit 4 and the driver does not recognize displayed information, it is possible to set a new moving path RTP1 indicated by the alternate long and short dash line in FIG. 10.

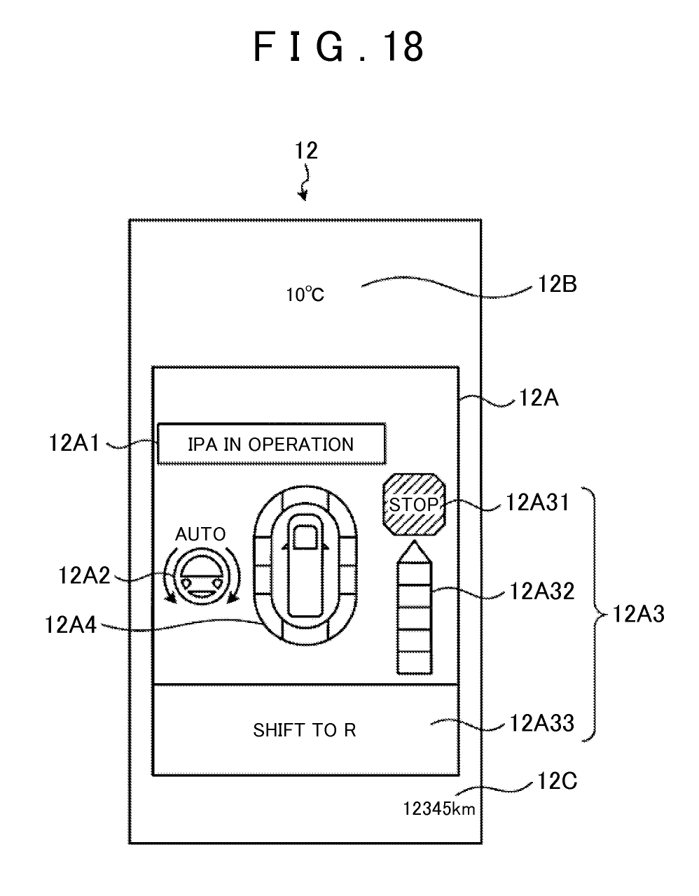

FIG. 18 is a view that illustrates an example of information display at a new switching position. When the ECU 14 proceeds to step S22 and detects that the host vehicle position has reached the position PP and the vehicle 1 is stopped (step S22), the ECU 14 sets the position PP for a new switching position instead of the switching position P2, sets the braking operation symbol 12A31 in a lit state, displays, for example, “SHIFT TO R” in the command display region 12A33, and issues an operation command to the driver to change the shift lever that serves as the shift operation unit 7 to reverse (R) (step S24).

Thus, when it is determined in step S25 that the host vehicle position has not reached the target position yet (No in step S25), and when it is determined in step S26 that the host vehicle position does not pass through the switching position by the predetermined amount because there is no next switching position (No in step S26), the ECU 14 functions as the moving path determination unit 144 again, recalculates a moving path, and resets a moving path (step S28).

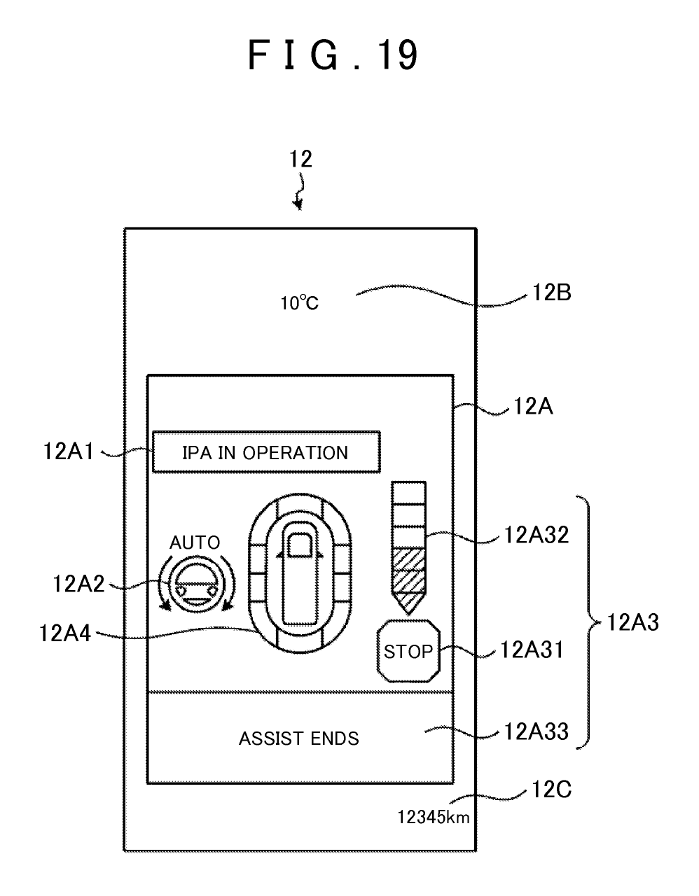

FIG. 19 is a view that illustrates an example of information display while the vehicle is moving backward. When the ECU 14 proceeds to step S22 again and detects that the host vehicle position has reached the position PP to stop the vehicle 1 and a change of the shift lever that serves as the shift operation unit 7 to reverse (R), the ECU 14 compares the host vehicle position with the set path (step S23), and issues an operation command to move the vehicle 1 backward (step S24).

Thus, when it is determined in step S25 that the host vehicle position has not reached the target position yet (No in step S25), and when it is determined in step S26 that the host vehicle position does not pass through the switching position by the predetermined amount because there is no next switching position (No in step S26), the ECU 14 functions as the moving path determination unit 144 again, recalculates a moving path, and resets a moving path (step S28).

The ECU 14 proceeds to step S22 again, detects the host vehicle position (step S22), compares the host vehicle position with the set path (step S23), and displays a measure of a distance to the moving target position by updating a lit state of the distance indication symbol 12A32 (step S24).

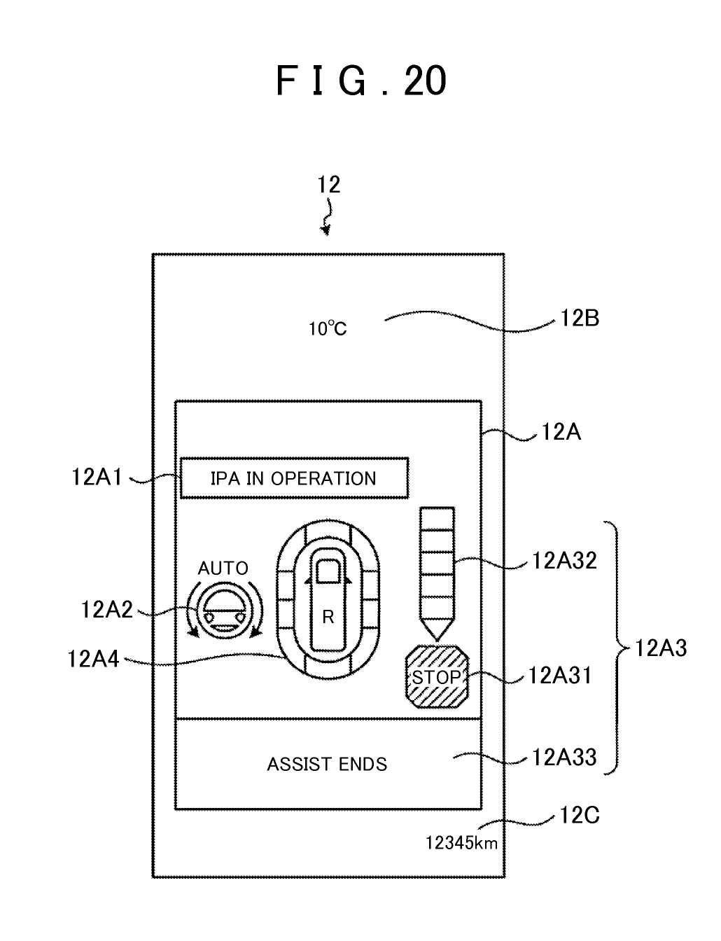

FIG. 20 is a view that illustrates an example of display at the end of parking assist. In addition, the ECU 14 proceeds to step S22 again through the processes of step S25, step S26 and step S28, detects the host vehicle position (step S22), compares the host vehicle position with the set path (step S23), displays vehicle state information and operation command information on the display screen of the display device 12 (step S24), cancels the automatic steering mode (step S29) when it is determined in step S25 that the host vehicle position has reached the parking position that is the target position, and displays the end of the parking assist process in the command display region 12A33 and ends the parking assist process.

As described above, according to the embodiment, even when information that is displayed on the display device 12 is hidden by the spoke, or the like, of the steering wheel that serves as the steering unit 4, it is possible to shift into a state where display of the display device 12 is reliably visually recognizable by the driver by driving the steering unit 4. Therefore, the driver is allowed to reliably acquire information required to move the vehicle 1 to the parking position, is allowed to reliably perform operation of the vehicle 1 required during parking assist, and is allowed to reliably perform parking.

The embodiment of the invention is described above; however, the embodiment is only illustrative and not intended to limit the scope of the invention. This novel embodiment may be implemented in other various forms, and may be variously omitted, replaced or changed without departing from the spirit of the invention. The scope and spirit of the invention encompass the embodiment and its modifications, and the invention described in the appended claims and equivalents thereof encompass these embodiments and their modifications.

For example, in the above description, when information that is displayed on the display device 12 is hidden by the spoke, or the like, of the steering wheel that serves as the steering unit 4, the steering unit 4 is driven to a state of the steering wheel where the rotation driving amount is the smallest and display of the display device 12 is visually recognizable. Instead, the steering unit 4 may be configured to be driven to any one of a neutral state (0 degrees), ±360-degree rotation state or ±720-degree rotation state.

In the above description, at the time of estimating the eye position, the monitored result of the driver monitoring device or the orientation of the rear-view minor is used. In addition, the eye position may be estimated by the use of a reclining angle of a power seat, a position of the power seat or a value of a steering column. In the above description, when the host vehicle position has passed through the switching position by the predetermined amount, the steering unit 4 is configured to be driven to a state where display of the display device 12 is visually recognizable by the driver. In addition to this, an exclusive bulb lamp that indicates that the host vehicle position has reached the switching position may be set to a lit state.

A first aspect of the invention provides a parking assist system for a vehicle. The vehicle includes a display device 12 that is arranged behind a steering wheel 4 from a driver and that displays parking assist information and a driving unit that rotationally drives the steering wheel. The parking assist system includes an electronic control unit 14a. The electronic control unit 14 is configured to detect that the vehicle has moved through a switching position P2 at which the steering wheel is required to turn and reached a predetermined state PP during parking assist, and, when it is detected that the vehicle has reached the predetermined state, control the driving unit to rotationally drive a rotation angle position of the steering wheel to a rotation angle position at which it is estimated that at least the parking assist information is visually recognizable by the driver. According to this aspect, when parking assist is performed, it is possible to reliably provide the driver with the parking assist information at the switching position in a visually recognizable state.

In the parking assist system according to the above aspect, the predetermined state may be a state where the vehicle has continued moving a predetermined distance or longer or for a predetermined time or longer after reaching the switching position. With the above configuration, it is possible to reliably provide the driver, who presumably does not visually recognize information at the switching position, with the information in a visually recognizable state, and allow the driver to visually recognize the parking assist information.

In the parking assist system according to the above aspect, the electronic control unit may be configured to calculate the rotation angle position of the steering wheel, at which it is estimated that display of at least the parking assist information is visually recognizable by the driver, on the basis of a current rotation angle position of the steering wheel. With the above configuration, it is possible to calculate the suitable rotation angle position of the steering wheel on the basis of the current angle position of the steering wheel.

In the parking assist system according to the above aspect, the electronic control unit may be configured to, when there are a plurality of the rotation angle positions of the steering wheel, at which it is estimated that display of at least the parking assist information is visually recognizable by the driver, calculate the rotation angle position of which a difference from the current rotation angle position is the smallest. With the above configuration, it is possible to reduce a difference in angle position before and after control, so the driver experiences a less feeling of strangeness and ease of use.

In the parking assist system according to the above aspect, the rotation angle position of the steering wheel, at which it is estimated that at least the parking assist information is visually recognizable by the driver, may include a state where the steering wheel is set at a neutral position. With the above configuration, it is possible to reliably provide the parking assist information in a visually recognizable state.

In the parking assist system according to the above aspect, the steering wheel may include a spoke, and the electronic control unit may be configured to set a rotation angle position, at which it is estimated that the spoke does not fall within a driver's visual field range of the parking assist information, for the rotation angle position of the steering wheel, at which it is estimated that display of at least the parking assist information is visually recognizable by the driver. With the above configuration, it is possible to reliably prevent the spoke of the steering wheel from interfering with visual recognition of the parking assist information.

In the parking assist system according to the above aspect, the electronic control unit may be configured to calculate the rotation angle position of the steering wheel, at which it is estimated that display of the parking assist information is visually recognizable, on the basis of a detected driver's face position. With the above configuration, it is possible to reliably provide the parking assist information at the driver's face position in a visually recognizable state.

The parking assist system according to the above aspect may further include a driver monitoring device configured to detect a state of the driver, and the electronic control unit may be configured to detect the driver's face position on the basis of a detected result of the driver monitoring device. With the above configuration, it is possible to reliably detect the driver's face position and provide the parking assist information at the driver's face position in a visually recognizable state.

The parking assist system according to the aspect may further include a mirror angle detection unit configured to detect an angle of a rear-view mirror mounted in the vehicle, and the electronic control unit may be configured to detect the driver's face position on the basis of the detected angle of the rear-view minor. With the above configuration, it is possible to detect the driver's face position on the basis of the angle of the rear-view minor that is assumed to be oriented toward the driver's face and provide the parking assist information at the driver's face position in a visually recognizable state.

A second aspect of the invention provides a parking assist method that is executed in a parking assist system mounted on a vehicle including a display device 12 that is arranged behind a steering wheel from a driver and that displays parking assist information. The parking assist method includes: detecting that the vehicle has moved through a switching position and reached a predetermined state during parking assist; and, when it is detected that the vehicle has reached the predetermined state, rotationally driving a rotation angle position of the steering wheel to a rotation angle position at which it is estimated that at least the parking assist information is visually recognizable by the driver. With the above configuration, when parking assist is performed, it is possible to reliably provide the driver with the information at the switching position in a visually recognizable state.

A third aspect of the invention provides a control program for controlling, by a computer, a parking assist system mounted on a vehicle including a display device that is arranged behind a steering wheel from a driver and that displays parking assist information and a driving unit that rotationally drives the steering wheel. The control program causes the computer to function as: means for detecting that the vehicle has moved through a switching position and reached a predetermined state during parking assist; and means for, when it is detected that the vehicle has reached the predetermined state, controlling the driving unit to set a rotation angle position of the steering wheel to a rotation angle position at which it is estimated that at least the parking assist information is visually recognizable by the driver. With the above configuration, when parking assist is performed, it is possible to reliably provide the driver with the information at the switching position in a visually recognizable state.

What is claimed is:

1. A parking assist system for a vehicle, the vehicle including
a display device that is arranged behind a steering wheel from a driver and that displays parking assist information, and
a driving unit that rotationally drives the steering wheel, the parking assist system comprising:
an electronic control unit configured to
detect that the vehicle has moved through a switching position at which the steering wheel is required to turn and reached a predetermined state during parking assist, and
when it is detected that the vehicle has reached the predetermined state, control the driving unit to rotationally drive a rotation angle position of the steering wheel to a rotation angle position at which it is estimated that at least the parking assist information is visually recognizable by the driver.

2. The parking assist system according to claim 1, wherein
the predetermined state is a state where the vehicle has continued moving a predetermined distance or longer or for a predetermined time or longer after reaching the switching position.

3. The parking assist system according to claim 1, wherein
the electronic control unit is configured to calculate the rotation angle position of the steering wheel, at which it is estimated that display of at least the parking assist information is visually recognizable by the driver, on the basis of a current rotation angle position of the steering wheel.

4. The parking assist system according to claim 3, wherein
the electronic control unit is configured to, when there are a plurality of the rotation angle positions of the steering wheel, at which it is estimated that display of at least the parking assist information is visually recognizable by the driver, calculate the rotation angle position of which a difference from the current rotation angle position is the smallest.

5. The parking assist system according to claim 1, wherein
the rotation angle position of the steering wheel, at which it is estimated that at least the parking assist information is visually recognizable by the driver, includes a state where the steering wheel is set at a neutral position.

6. The parking assist system according to claim 1, wherein
the steering wheel includes a spoke, and
the electronic control unit is configured to set a rotation angle position of the steering wheel, at which it is estimated that the spoke does not fall within a driver's visual field range of the parking assist information, to the rotation angle position of the steering wheel, at which it is estimated that display of at least the parking assist information is visually recognizable by the driver.

7. The parking assist system according to claim 1, wherein
the electronic control unit is configured to calculate the rotation angle position of the steering wheel, at which it is estimated that display of the parking assist information is visually recognizable, on the basis of a detected driver's face position.

8. The parking assist system according to claim 7, further comprising:
a driver monitoring device configured to detect a state of the driver, wherein
the electronic control unit is configured to detect the driver's face position on the basis of a detected result of the driver monitoring device.

9. The parking assist system according to claim 7, further comprising:
a mirror angle detection unit configured to detect an angle of a rear-view minor mounted in the vehicle, wherein
the electronic control unit is configured to detect the driver's face position on the basis of the detected angle of the rear-view minor.

10. The parking assist system according to claim 1, wherein
the switching position is a position at which the steering wheel is required to turn and at which a moving direction of the vehicle is changed between a forward direction and a reverse direction.

11. A parking assist method that is executed in a parking assist system mounted on a vehicle including a display device that is arranged behind a steering wheel from a driver and that displays parking assist information, the parking assist method comprising:
detecting that the vehicle has moved through a switching position at which the steering wheel is required to turn and reached a predetermined state during parking assist; and
when it is detected that the vehicle has reached the predetermined state, rotationally driving a rotation angle position of the steering wheel to a rotation angle position at which it is estimated that at least the parking assist information is visually recognizable by the driver.

12. The parking assist method according to claim 11, wherein
the predetermined state is a state where the vehicle has continued moving a predetermined distance or longer or for a predetermined time or longer after reaching the switching position.

13. The parking assist method according to claim 11, further comprising:
calculating the rotation angle position of the steering wheel, at which it is estimated that display of at least the parking assist information is visually recognizable by the driver, on the basis of a current rotation angle position of the steering wheel.

14. The parking assist method according to claim 13, wherein
when there are a plurality of the rotation angle positions of the steering wheel, at which it is estimated that display of at least the parking assist information is visually recognizable by the driver, the rotation angle position of which a difference from the current rotation angle position is the smallest is calculated.

15. The parking assist method according to claim 11, wherein
the rotation angle position of the steering wheel, at which it is estimated that at least the parking assist information is visually recognizable by the driver, includes a state where the steering wheel is set at a neutral position.

16. The parking assist method according to claim 11, wherein
the steering wheel includes a spoke, and
the parking assist method further comprising setting a rotation angle position of the steering wheel, at which it is estimated that the spoke does not fall within a driver's visual field range of the parking assist information, to the rotation angle position of the steering wheel, at which it is estimated that display of at least the parking assist information is visually recognizable by the driver.

17. A control program for controlling, by a computer, a parking assist system mounted on a vehicle including a display device that is arranged behind a steering wheel from a driver and that displays parking assist information and a driving unit that rotationally drives the steering wheel, the control program causing the computer to function as:
means for detecting that the vehicle has moved through a switching position at which the steering wheel is required to turn and reached a predetermined state during parking assist; and
means for, when it is detected that the vehicle has reached the predetermined state, controlling the driving unit to set a rotation angle position of the steering wheel to a rotation angle position at which it is estimated that at least the parking assist information is visually recognizable by the driver.

18. The control program according to claim 17, wherein
the predetermined state is a state where the vehicle has continued moving a predetermined distance or longer or for a predetermined time or longer after reaching the switching position.

19. The control program according to 17, wherein
the control program further causes the computer to function as means for calculating the rotation angle position of the steering wheel, at which it is estimated that display of at least the parking assist information is visually recognizable by the driver, on the basis of a current rotation angle position of the steering wheel.

20. The control program according to claim 19, wherein
the control program causes the computer to function as means for, when there are a plurality of the rotation angle positions of the steering wheel, at which it is estimated that display of at least the parking assist information is visually recognizable by the driver, calculating the rotation angle position of which a difference from the current rotation angle position is the smallest.

21. The control program according to claim 17, wherein
the rotation angle position of the steering wheel, at which it is estimated that at least the parking assist information is visually recognizable by the driver, includes a state where the steering wheel is set at a neutral position.
